(19) United States
(12) Patent Application Publication
(10) Pub. No.: US 2023/0175441 A1
(43) Pub. Date: Jun. 8, 2023

(54) SYSTEMS AND METHODS FOR COMMUNICATION FOR A DISTRIBUTED CONTROL MODULE

(71) Applicant: General Electric Company, Schenectady, NY (US)

(72) Inventors: David A. Langan, Clifton Park, NY (US); Richard Joseph Gawrelski, Amsterdam, NY (US); Emad A. Andarawis, Ballston Lake, NY (US); Andrew W. Berner, Waterford, NY (US); Andrea Marie Schmitz, Halfmoon, NY (US); Richard St-Pierre, Clifton Park, NY (US)

(21) Appl. No.: 17/545,321

(22) Filed: Dec. 8, 2021

(51) Int. Cl. F02C 9/00; H04L 12/40; G06F 21/60; B64D 31/00

(52) U.S. Cl. CPC F02C 9/00; B64D 31/00; G06F 21/602; H04L 12/40032; F05D 2220/323; F05D 2270/00; H04L 2012/4028

(57) ABSTRACT

A control system for an engine includes a distributed control module configured to be associated with a sensor of the engine, a digital link, and a communication control. The distributed control module is connected to the communication control via the digital link. The communication control includes a bus communication engine configured to communicate with the engine control via a bus, and a memory. The memory includes a first buffer that is associated with the distributed control module and a second buffer that is associated with the bus communication engine.

### FIELD

The present disclosure relates to systems and methods for communication for a distributed control module.

### BACKGROUND

Distributed nodes of a control system are increasingly designed to be able to communicate with one another. Real-time communications are necessary, for example, to monitor system information or for control loops to operate on distributed measurements at the distributed nodes.

For example, to reduce communication traffic and processing at an Engine Control Unit (ECU), it is desirable to be able to perform important functions at nodes and to coordinate function-related information (e.g., sensor measurements, actuator position, etc.) between the nodes. Accordingly, each node needs to have a certain amount of processing resources to perform their function and communicate with other elements of the control system. In particular, each node needs to have processing resources to provide the information to a desired location in a time-sensitive manner.

Harsh environments (particularly heat) often constrain the electronics that may be employed, thereby constraining processing resources. The processing resources may have to be limited due to electronics availability and capability at higher heat loads.

In addition, communication between nodes may require more processing and stricter timing constraints than is needed to perform its function. Additionally, computation resources may be challenged and perhaps slowed by encryption or other cybersecurity requirements, and by other resources using a communication bus. Employment of encryption for secure communications significantly adds to the processing requirements while concurrently posing a challenge to meet communication latency constraints. A delay in communication of information may result in having sensor measurements with different time stamps, which can impact decisions at the ECU and adjustment responses, and therefore reduce the precision of control loops and require additional time to reach a desired engine state.

Accordingly, systems and methods to improve communication and improve the precision of control loops would be welcomed in the art.

### BRIEF DESCRIPTION OF THE DRAWINGS

A full and enabling disclosure of the present disclosure, including the best mode thereof, directed to one of ordinary skill in the art, is set forth in the specification, which refers to the appended figures, in which:

FIG. 1 is a schematic view of an aircraft including a control system, in accordance with an exemplary aspect of the present disclosure.

FIG. 2 is a schematic view of part of the control system of FIG. 1, in accordance with an exemplary aspect of the present disclosure.

FIG. 3 is an exemplary method in accordance with an exemplary aspect of the present disclosure.

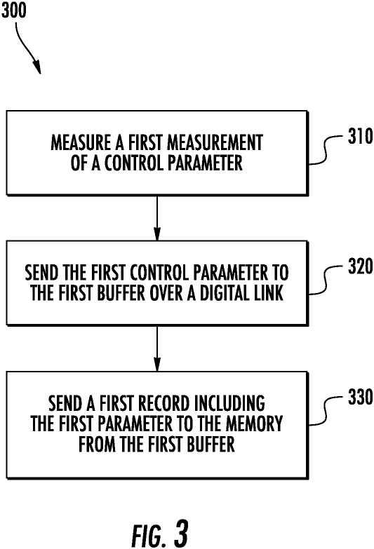

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle and refer to the normal operational attitude of the aircraft engine, gas turbine engine or vehicle. For example, regarding an aircraft engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

The present disclosure is generally related to systems and methods for communication for a distributed control module. In particular, the present disclosure is generally related to systems and methods for partitioning communication responsibilities (e.g., bus coordination, encryption) of a distributed control module from functional responsibilities (e.g., measurement, actuation) of the distributed control module. For example, the communication responsibilities are performed separately by a communication control and the functional responsibilities performed by the distributed control module may be asynchronous with respect to the communication responsibilities of the communication control.

Partitioning distributed control module communication from distributed control module function has several advantages. First, as the functionality of a single implementation of a communication needs to be validated, validation and cross-validation of multiple communication implementations are avoided. Second, distributed control module manufacturers can design and validate actuators, sensors, etc., without the added complexity introduced by the design and validation of specified bus communications for each system in which the distributed control module is deployed. Additionally, functional changes can be made to a sensor or actuator design and the resulting changes to functional requirements of the distributed control module (including factors that affect processing and execution time) can be made without changes to communication requirements, which are decoupled and independent from the functional requirements.

By partitioning communication responsibilities from the distributed control module, communication of information associated with the functional responsibilities does not require coordination with multiple other controllers. Instead, the distributed control module is uniquely connected to the communication control, and the communication control provides communication responsibilities and coordinates information with other controllers.

As communication responsibilities for the distributed control module are simplified, the information associated with the functional responsibilities may be communicated between the distributed control module and the communication control over a serial link. For example, bits of data can be provided one after another in sequence, without the need to clock each bit so that the bits can be separated and recombined. Accordingly, the serial link requires fewer processing resources, provides greater data integrity, and is faster.

In addition, the communication control may include a first buffer for sending and receiving data to and from the distributed control over the serial link and a separate second buffer for sending and receiving data over a bus, for example, from an engine control. The first buffer provides that data can be sent or received to or from the first buffer to or from the distributed control module without coordination with other data that is sent or received to or from an engine control over the bus as such data is queued in the second buffer.

Data that is sent to or the first buffer from the distributed control module may include a plurality of control parameters. The plurality of control parameters may be grouped in a record in the first buffer such that all the control parameters have a single time stamp before moving the record from the first buffer to the memory of the communication control or moving to the second buffer to send to an engine control module.

Using the serial link and the first buffer, communication between the distributed control module and the communication control is invariable, uninterrupted, and/or otherwise does not tie up processing resources. In some cases, data from the distributed control module may be memory-mapped to addresses or locations in the first buffer and/or memory. An address may be associated with the data, or the data may be defined to be an address and measurement.

As communication over the serial link to the first buffer is invariable or otherwise does not tie up processing resources (e.g., with coordination of communication over a bus), the distributed control module may continuously collect data, improve the precision of control loops, and close control loops faster.

The communication control is responsible for resource-intensive communication such as coordination with other controllers and encryption of data. Processing resources can be concentrated in the communication control as the communication control may be located away from high-temperature environments. Providing coordination and encryption by the same control efficiently uses processing resources.

In addition, modularization between functional and communication responsibilities provides, for example, that the communication control may be updated without requiring updates to (or recertifying) the distributed control module. Updates to the communication control may include changing cybersecurity requirements or communication protocols. As the communication and cybersecurity requirements of the distributed control module are limited or removed using the serial link and the double-buffered memory, changes to the communication control may be made without changes to the distributed control module.

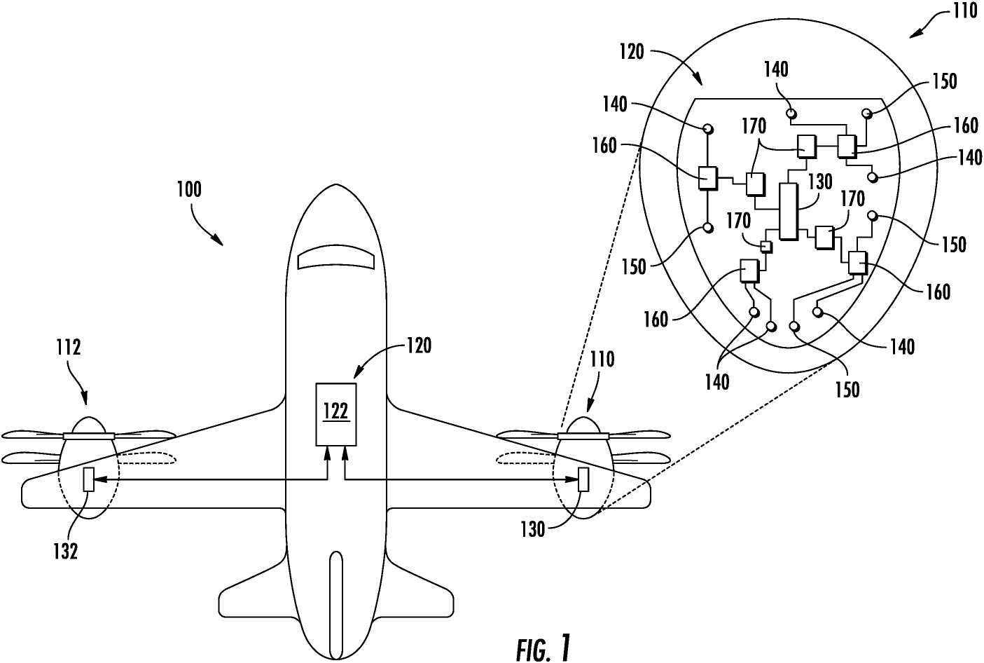

Referring now to the drawings, wherein identical numerals indicate the same elements throughout the figures, FIG. 1 provides a schematic illustration of an aircraft 100 including engines 110, 112. The aircraft 100 includes a control system 120 to monitor and control operations of the aircraft 100 including to monitor and control operations of the engines 110, 112.

Although a control system is described in the context of an aircraft platform, the systems and methods described herein are applicable to other systems, and particularly to those including harsh environments. Harsh environments may include high temperature environments, high radiation environments, environments with low power availability, combinations thereof, and the like. Such harsh environments may be found in aircraft platforms, in oil and gas platforms, in power generation platforms, in automotive platforms, and the like.

The control system 120 includes an aircraft controller 122. The aircraft controller 122 may include manual aircraft controls, a flight management system, and the like. The aircraft controller 122 may be located to be separate from the engines 110, 112.

The control system 120 further includes components that may be located on, in, or near the engines 110, 112 including engine controls 130, 132, sensors 140, actuators 150, distributed control modules (DCMs) 160 (e.g., distributed engine controls or distributed engine controllers), and communication controls 170. For purposes of teaching, the sensor 140, actuators 150, distributed control modules 160, and communication controls 170 are illustrated with respect to engine 110 and the description of these components of control system 120 is applicable to the engine 112 and to engines of aircraft with more than two engines.

The engine controls 130, 132 may be a Full Authority Digital Engine Control (FADEC) for providing full digital control of the engine 110, an engine control unit (ECU), or the like. In other embodiments including those where the control system is used in other environments, the engine control may be a supervisory control.

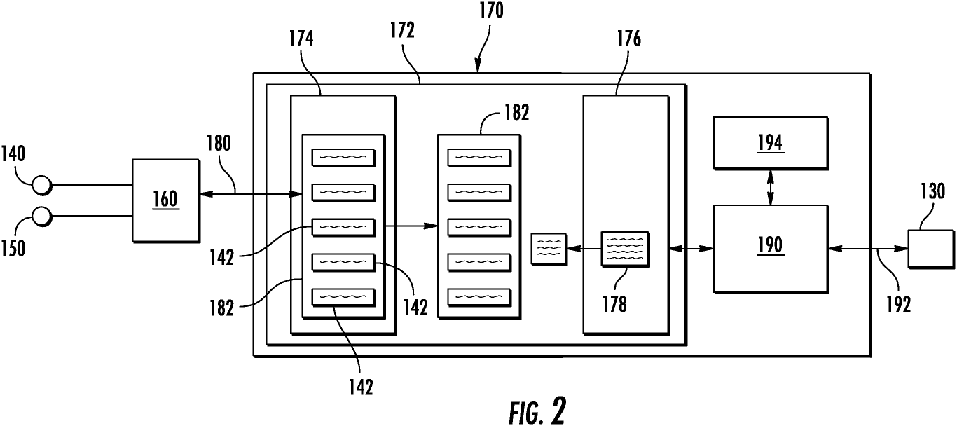

The sensors 140 measure control parameters 142 that are related to the operation of the engine 110 and/or the aircraft 100. For example, the data measured by the sensors 140 may be evaluated to determine one or more values that represent a control parameter 142 (shown in FIG. 2).

The sensors 140 are illustrated as end nodes (e.g., downstream ends or distal ends) of the control system 120 on the engine 110. It is contemplated that the control system 120 may include other engine or aircraft sensors at other locations on the engine 110 or aircraft 100.

The sensors 140 may include pressure transducers, total air temperature sensors for bleed air, core-mounted digital pressure transducers, high temperature pressure sensors, platinum resistance temperature detectors (RTD), thermocouples (e.g., type K, N, or S), speed and torque sensors for shaft, blade, and gear measurement, combinations thereof and the like.

In high temperature environments, electronics (e.g., distributed control module 160 and communication control 170) and sensors 140 may be exposed to temperatures greater than 125 C. Electronics may be designed with to withstand temperatures in a range of 200-300 C whereas sensors may need to be able to withstand much higher temperatures. For example, a thermocouple may withstand temperatures greater than 500 C. Sensors may have to withstand higher temperatures due to placement in a hot gas path, whereas electronics may reside outside the flow of the hot gas path.

Control parameters 142 can include parameters of the engine 110 such as exhaust gas temperature and oil temperature; component temperatures such as high pressure turbine shroud temperature, engine fuel flow, core speed, compressor discharge pressure, turbine exhaust pressure, and fan speed; parameters of the aircraft 100 such as altitude, ambient temperature, ambient pressure and air speed; and the like.

Actuators 150 include engine actuators that perform an operation to change geometries or operational conditions of the engine 110. For example, the actuators 150 may perform an action as part of a control loop to adjust or maintain the one or more of the control parameters 142. The actuators 150 are illustrated as end nodes (e.g., downstream ends or distal ends) of the control system 120 on the engine 110. However, it is contemplated that the actuators 150 may include other engine or aircraft actuators at other locations on the aircraft 100.

Actuators 150 may include linear or rotary actuators (e.g., for inlet guide vanes or stator guide vanes), electro-hydraulic servo-valves, fuel pumps, fuel metering, gearboxes, bleed controls or valves, and the like.

The control system 120 includes a plurality of distributed control modules (DCM) 160. A distributed control module 160 may include or be connected to one or more sensors 140 and one or more actuators 150. Alternatively or additionally, a distributed control module 160 may include or be a smart sensor. In some examples, a distributed control module 160 may be designed to operate in high temperature environments by reducing heat loads through lower performance requirements.

The distributed control modules 160 are connected to communication controls 170 and may be described as being downstream or distal from the communication control 170. Accordingly, the sensor 140, actuator 150, and distributed control module 160 are downstream or distal from the communication control 170. The communication control 170 is an intermediate interface between the distributed control module 160 and an engine control 130.

The communication control 170 may be or include an integrated circuit such as an application specific integrated circuit (ASIC), a field-programmable gate array (FPGA), or the like.

Referring to FIG. 2, for purposes of teaching, a branch of the control system 120 is described in further detail. In particular, a distributed control module 160 and a communication control 170 are described in further detail.

In FIG. 2, the distributed control module 160 is illustrated as being connected to one sensor 140 and one actuator 150. However, the description of the distributed control module 160 is applicable to other distributed control modules that may be connected to or include one or more sensors 140 and/or one or more actuators 150.

The communication control 170 includes a memory 172. The memory 172 (e.g., a double buffered memory or a multi-buffered memory) includes a first buffer 174 and a second buffer 176. The first buffer 174 and the second buffer 176 (e.g., data buffers) are regions (e.g., fixed memory locations) of the memory 172 that are used to temporarily store data before moving the data into the memory 172 or to the other buffer. Data from the distributed control module 160 is stored in the first buffer 174.

On the side of the second buffer 176, the second buffer 176 facilitates communication-related processing including data preprocessing (for example, encryption, compression such as a Huffman code, etc.); bus protocol management; computing error detecting code such as cyclic redundancy check (CRC) and parity; and transmission via a transceiver. Data (e.g., commands 178) from the engine control 130 (or another upstream control) is stored in the second buffer 176.

The distributed control module 160 may be connected to the communication control 170 by a digital link 180. The digital link 180 is a connection or communication channel over which data may be sent or received one bit at a time, sequentially.

As the data sent over the digital link 180 does not require communication-based processing (e.g., processing to send over parallel channels) to be sent over the digital link 180, the digital link 180 provides high signal integrity, low latency, and is deterministic, both of which are important for engine control.

For purposes of teaching, a digital link 180 is described as a serial link. A serial link may be synchronous, asynchronous, parity, CAN, Ethernet, RS485, RS422, ARINC, Mil-Std-1553, USB, any type of simple digital communication that is reliable over a short distance, and the like.

The distributed control module 160 does not require communication with other controllers, for example, to perform a data retrieval function of the distributed control module 160. The distributed control module 160 may provide function-related responsibilities including updating data in the first buffer 174 and retrieving commands 178 from the memory 172 or second buffer 176. Communication-related responsibilities for the data in the memory are provided by the communication control 170.

The double buffered memory facilitates asynchronous communication between the distributed control module 160 and the engine control 130. For example, the engine control 130 writes to the distributed control module 160 and the data is stored in the second buffer 176. When the write is complete, the bus communication engine 190 propagates the data to the first buffer 174 (to the distributed control module 160) in a single clock cycle so the entire record travels together.

The inverse happens from the distributed control module 160 to the engine control 130. The distributed control module 160 writes to the first buffer 174. When the distributed control module 160 has written a complete record (e.g., record 182) to the first buffer 174, the distributed control module 160 requests propagation to the second buffer 176 to send to the engine control 130.

In this manner, the distributed control module 160 and the engine control 130 see complete records, not portion of two records mixed together.

In the case where multiple sensors 140 are associated with the distributed control module 160, the distributed control module 160 may be a data concentrator, aggregating data from multiple sensors 140 and communicating the data over the digital link 180 to the communication control 170. The data from sensors 140 may be communicated over the digital link 180 to the communication control 170 based on a schedule or other request from the engine control 130. The collection of the data by the distributed control module 160 may be asynchronous from the communication of the data to the communication control 170. Here, there may be some data error that is corrected with a method of error detection such as using a parity bit.

Alternatively or additionally, the distributed control module 160 may write to a first record 182 of measurements of control parameters 142 in the first buffer 174 of the memory 172. The first record 182 may be updated asynchronously with respect to communication between the communication control 170 and other controllers or nodes of the control system 120. For example, the record 182 may be updated periodically, on a clock cycle, or in response to a request signal from the communication control 170 or another upstream control.

As communication over the digital link 180 to the first buffer 174 does not tie up processing resources (e.g., with coordination of communication over a bus), the distributed control module 160 may continuously collect data and close control loops faster. As used herein, the term “asynchronous” may refer to data that can be transmitted independent of requirements of another node of the control system 120 or a bus.

The values of the control parameters 142 in the first record 182 may be time-stamped. The speed of the digital link 180 and use of the first buffer 174 allows the values of control parameters 142 to be grouped for a single time stamp and otherwise removes timing ambiguity. For purposes of control and monitoring, the record 182 is associated with a single time stamp.

In contrast, as described in further detail below, using parallel channels or communicating over a bus may involve encryption and additional processing. Additional processing may be involved as each bit of data is clocked and is coordinated with other bits of clocked data moving through parallel channels. Additional processing or encryption time may result in a record spanning two time stamps, for example, as a first control parameter is updated (e.g., a time stamp “n+1”) but a second control parameter is not yet updated (e.g., a time stamp “n”). For example, the precision of a control loop using control parameters 142 in the first record 182 may suffer if the first record 182 is not associated with a single time stamp.

The first record 182 may be passed from the first buffer 174 to the memory 172 (or to the second buffer 176) and the control parameters 142 of the first record 182 may be used for monitoring and control operations. For example, the first record 182 may be passed from the first buffer 174 to the memory 172 asynchronously, periodically, at a time increment, upon request, and the like.

Data can be transferred to the first buffer 174 each time the data in the first buffer 174 is transferred to the memory 172 or otherwise emptied. For example, a first record 182 (e.g., time stamp “n”) can be transferred from the first buffer 174 to the memory 172, and a second record 182 (e.g., time stamp “n+1”) can be written to or transferred in to the first buffer 174.

The communication control 170 includes a bus communication engine 190 (e.g., a host processor) that is configured to communicate with the engine control 130 (or another upstream controller) via a bus 192. The engine control 130 may interface with the aircraft controller 122 via the bus 192.

The bus 192 (e.g., a communication data bus) is a communication system that may include hardware components (e.g., wire, optical fibers, etc.) and software including communication protocols. The bus 192 transfers data between computers or computer components. For reference, the bus 192 may include or coordinate communication over wireless links such as 802.11, Zigbee, Bluetooth and 5G; and parallel links such as ISA, ATA, SCSI, PCI and IEEE-488.

The communication control 170 includes a cybersecurity module 194. For example, the cybersecurity module 194 is configured to encrypt data (e.g., a record 182) that retrieved from the memory 172 and sent over the bus 192 to the engine control 130; and to decrypt data that is received from the engine control 130 and stored in the memory 172 via the second buffer 176. The cybersecurity module 194 may further provide additional cryptography functions, and the like.

Referring particularly to the operation of the communication control 170, in at least certain embodiments, the communication control 170 may be or include one or more computing device(s).

Other components of the control system 120, including the aircraft controller 122, the engine controls 130, 132, and the distributed control module 160, may be or include computing devices and the description with respect to communication control 170 and/or computer components in general is applicable to these components of the control system 120.

The computing device(s) can include one or more processor(s) (e.g., bus communication engine 190) and one or more memory device(s) (e.g., memory 172).

The one or more processor(s) can include any suitable processing device, such as a microprocessor, microcontroller, integrated circuit, logic device, and/or other suitable processing device.

The one or more memory device(s) can include one or more computer-readable media, including, but not limited to, non-transitory computer-readable media, RAM, ROM, hard drives, flash drives, and/or other memory devices.

The one or more memory device(s) can store information accessible by the one or more processor(s), including computer-readable instructions (e.g., commands 178) that can be executed by the one or more processor(s). The instructions can be any set of instructions that when executed by the one or more processor(s), cause the one or more processor(s) to perform operations.

In some embodiments, the instructions can be executed by the one or more processor(s) to cause the one or more processor(s) to perform operations, such as any of the operations and functions for which the communication control 170 and/or the computing device(s) are configured, the operations for operating an engine 110 (e.g., methods described below), as described herein, and/or any other operations or functions of the one or more computing device(s). The instructions can be software written in any suitable programming language or can be implemented in hardware. Additionally, and/or alternatively, the instructions can be executed in logically and/or virtually separate threads on processor(s).

For example, the cybersecurity module 194 can be implemented as a control module including instructions that are executed to provide the communication and encryption functionality.

The memory device(s) can further store data (e.g., first record 182 of control parameters 142 and the command 178) that can be accessed by the processor(s). For example, the data can include data indicative of evaluations of control parameters, data indicative of engine/ aircraft operating conditions, DCM health data, engine health data, maintenance or system status data, and/or any other data and/or information described herein.

The computing device(s) can also include a network interface (e.g., digital link 180 or bus 192) used to communicate, for example, with the other components (e.g., of the control system 120, etc.) For example, in the embodiment depicted, as noted above, the engine 110 includes one or more sensors 140 for sensing data indicative of one or more control parameters 142 of the engine 110, the aircraft 100, or both.

The communication control 170 is operably coupled to the one or more sensors 140 through, e.g., the network interface, such that the communication control 170 may receive data indicative of various operating parameters sensed by the one or more sensors during operation.

The network interface can include any suitable components for interfacing with one or more network(s), including for example, transmitters, receivers, ports, controllers, antennas, and/or other suitable components.

The technology discussed herein refers to computer-based systems, and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The engine control 130 is connected via the bus 192 (e.g., a dedicated cable harness) to the communication controls 170, and, via the digital links 180 from the communication controls 170, to the sensors 140 and actuators 150.

According to various aspects of monitoring and control methods, the engine control 130 may receive a command (e.g., a thrust request) from the aircraft controller 122 and generate commands to operate actuators 150. The engine control 130 may also monitor the measurements of control parameters 142 and generate commands to implement control functions via the actuators 150 based on the measurements of control parameters 142.

For example, the bus communication engine 190 may receive a command 178 from the engine control 130 over the bus 192, the cybersecurity module 194 may decrypt the command 178, and the bus communication engine 190 may transfer the command 178 to the second buffer 176. The second buffer 176 queues the command 178 for transfer to the memory 172 or the first buffer 174, where the command 178 is accessed by the distributed control module 160 and implemented (e.g., with an actuator 150).

The distributed control module 160 may receive data from the engine control 130 (e.g., a FADEC). This data may be a combination of commands 178 or control instructions (e.g., adjust the fuel valve to 80%) and auxiliary information needed by the distributed control module 160 to perform its function.

The command 178 may include interacting with sensors 140 to close a control loop. For example, the distributed control module 160 may implement the command 178 by repeatedly measuring a temperature with a sensor 140 and reporting the temperature of the sensor 140. When the temperature reaches a control temperature, the distributed control module 160 closes the control loop and reports that the temperature has reached the control temperature.

The communication or data transfer between the distributed control module 160 and the communication control 170 may be coordinated per a predetermined schedule or as requested by the engine control 130 (e.g., a FADEC/ECU). For example, the engine control 130 may gather the “latest” measurement from the distributed control module 160 every ten milliseconds.

As the collection of the data from the sensors 140 by the distributed control module 160 is asynchronous with respect to when the engine control 130 gathers the latest measurement of the data, there may be some time error between the measurements that may be corrected with a method such as using a parity bit. However, because the digital link 180 is digital, simple, and robust, other errors due to communication are avoided. In addition, a record 182 may be created to ensure the data has the same time stamp.

In addition, the communications from the distributed control module 160 to the communication control 170, and communications from the communication control 170 over the bus 192 are asynchronous. The communication control 170 may send the latest record 182 it has over the bus 192 and receive updated instructions (e.g., commands 178) to pass to the distributed control module 160.

The measurements of control parameters 142 may also be received from a record 182 of measurements of control parameters 142 that is provided from the distributed control module 160 over the digital link 180 and through the first buffer 174 to the memory 172. The bus communication engine 190 may access the record 182 from the memory 172, the cybersecurity module 194 may encrypt the record 182, and the bus communication engine 190 may process the record 182 for communication over the bus 192.

For example, according to a first step 310 of an exemplary method 300, the sensor 140 measures a first measurement of a control parameter 142 of the engine 110. The first measurement has a first time stamp. For example, the control parameter 142 may be a temperature that is measured at a first time.

According to a second step 320, the distributed control module 160 sends, over the digital link 180, the first measurement of the control parameter 142 to the first buffer 174 of the memory 172. Sending the first measurement of the control parameter 142 over the digital link 180 includes writing the first measurement of the control parameter 142 to the first record 182. Each of the plurality of measurements of control parameters 142 in the first record 182 have the first time stamp.

According to a third step 330, the first buffer 174 sends the first record 182 from the first buffer 174 to the memory 172 for access by the bus communication engine 190. The third step 330 may additionally include accessing the first record 182 from the memory 172 with the bus communication engine 190, encrypting the first record 182 with the cybersecurity module 194, and preparing the encrypted first record 182 to send over the bus 192. For example, the temperature that is measured at a first time is stored or encrypted to send over the bus 192. The temperature may be sent to a FADEC for purposes of monitoring or control.

Steps 310, 320, 330 may be repeated for a second measurement such that the distributed control module 160 sends, over the digital link 180, a second measurement of the control parameter 142 to the first buffer 174. The second measurement has a second time stamp that is different from the first time stamp of the first measurement. Sending the second measurement of the control parameter 142 over the digital link 180 includes writing the second measurement of the control parameter 142 to a second record 182. Each of the plurality of measurements of control parameters 142 in the second record 182 have a second time stamp.

The technical effects and benefits include the following.

By partitioning communication responsibilities from the distributed control module, communication of information associated with the functional responsibilities does not require coordination with multiple other controllers. Instead, the distributed control module is uniquely connected to the communication control, and the communication control provides communication responsibilities and coordinates information with other controllers.

As communication responsibilities for the distributed control module are simplified, the information associated with the functional responsibilities may be communicated between the distributed control module and the communication control over a serial link. For example, bits of data can be provided one after another in sequence, without the need to clock each bit so that the bits can be separated and recombined. Accordingly, the serial link requires fewer processing resources, provides greater data integrity, and is faster.

In addition, the communication control may include a first buffer for sending and receiving data to and from the distributed control over the serial link and a separate second buffer for sending and receiving data over a bus, for example, from an engine control. The first buffer provides that data can be sent or received to or from the first buffer to or from the distributed control module without coordination with other data that is sent or received to or from an engine control over the bus as such data is queued in the second buffer.

Data that is sent to or the first buffer from the distributed control module may include a plurality of control parameters. The plurality of control parameters may be grouped in a record in the first buffer such that all the control parameters have a single time stamp before moving the record from the first buffer to the memory of the communication control or moving to the second buffer to send to an engine control module.

Using the serial link and the first buffer, communication between the distributed control module and the communication control is invariable, uninterrupted, and/or otherwise does not tie up processing resources. In some cases, data from the distributed control module may be memory-mapped to addresses or locations in the first buffer and/or memory. An address may be associated with the data, or the data may be defined to be an address and measurement.

As communication over the serial link to the first buffer is invariable or otherwise does not tie up processing resources (e.g., with coordination of communication over a bus), the distributed control module may continuously collect data, improve the precision of control loops, and close control loops faster.

The communication control is responsible for resource-intensive communication such as coordination with other controllers and encryption of data. Processing resources can be concentrated in the communication control as the communication control may be located away from high-temperature environments. Providing coordination and encryption by the same control efficiently uses processing resources.

In addition, modularization between functional and communication responsibilities provides, for example, that the communication control may be updated without requiring updates to (or recertifying) the distributed control module. Updates to the communication control may include changing cybersecurity requirements or communication protocols. As the communication and cybersecurity requirements of the distributed control module are limited or removed using the serial link and the double-buffered memory, changes to the communication control may be made without changes to the distributed control module.

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A control system for an engine, the engine comprising an engine control and a sensor defining a control parameter, the sensor configured to measure the control parameter of the engine, the control system comprising: a distributed control module configured to be associated with the sensor; a digital link; and a communications control, the distributed control module connected to the communication control via the digital link, the communication control comprising: a bus communication engine configured to communicate with the engine control via a bus; and a memory, comprising: a first buffer that is configured to send data to and receive data from the distributed control module over the digital link; and a second buffer that is configured to send data to and receive data from the engine control via the bus.

The control system of one or more of these clauses, wherein the distributed control module is associated with an actuator of the engine.

The control system of one or more of these clauses, wherein the sensor and the distributed control module are configured to operate in a high temperature environment.

The control system of one or more of these clauses, wherein data is at least one of sent and received one bit at a time, sequentially, over the digital link.

The control system of one or more of these clauses, wherein the distributed control module is configured to send a measurement of the control parameter over the digital link.

The control system of one or more of these clauses, wherein the control parameter is one of a plurality of control parameters, wherein the sensor is one of a plurality of sensors, wherein the first buffer includes a first record including a first plurality of measurements of control parameters from the plurality of sensors, wherein each of the first plurality of measurements of control parameters in the first record has a first time stamp.

The control system of one or more of these clauses, wherein the first buffer is configured to send the first record to the second buffer.

The control system of one or more of these clauses, wherein, after sending the first record to the second buffer, the first buffer includes a second record including a second plurality of measurements of control parameters from the plurality of sensors, wherein each of the second plurality of measurements of control parameters in the second record has a second time stamp, wherein the second time stamp is different from the first time stamp.

The control system of one or more of these clauses, wherein the measurement of the control parameter from the sensor is mapped to at least one of an address and a location of the first buffer.

The control system of one or more of these clauses, wherein the bus communication engine is configured to perform at least one of data preprocessing, encryption, bus protocol management, and transmission.

The control system of one or more of these clauses, wherein the engine control includes at least one of a full authority digital engine control and an engine control unit.

The control system of one or more of these clauses, wherein the communication control is an intermediate interface between the distributed control module and the engine control.

A method of controlling an engine, comprising: measuring a first measurement of a control parameter of the engine with a sensor; sending, over a digital link, from a distributed control module associated with the sensor, the first measurement of the control parameter to a first buffer of a memory; and wherein a communication control includes the memory and the memory further includes a second buffer that is associated with a bus communication engine of the communication control, wherein the communication control is an intermediate interface between the distributed control module and an engine control.

The method of one or more of these clauses, wherein sending over the digital link includes sending data one bit at a time, sequentially.

The method of one or more of these clauses, wherein sending over the digital link includes sending data asynchronously with respect to data sent or received at the second buffer.

The method of one or more of these clauses, wherein sending to the first buffer includes sending the first measurement of the control parameter to at least one of an address and a location of the first buffer that is mapped to the control parameter.

The method of one or more of these clauses, wherein the first buffer includes a first record including a first plurality of measurements of control parameters from a plurality of sensors, wherein sending over the digital link includes writing the first measurement of the control parameter to the first record.

The method of one or more of these clauses, comprising sending the first record from the first buffer to the memory for access by the bus communication engine, wherein each of the first plurality of measurements of control parameters in the first record has a first time stamp.

The method of one or more of these clauses, comprising sending, over the digital link, from the distributed control module associated with the sensor, a second measurement of the control parameter to the first buffer of the memory; wherein the first buffer includes a second record including a second plurality of measurements of control parameters from the plurality of sensors, wherein sending over the digital link includes writing the second measurement of the control parameter to the second record; and wherein each of the second plurality of measurements of control parameters in the second record have a second time stamp, wherein the second time stamp is different from the first time stamp.

The method of one or more of these clauses, comprising: accessing, by the bus communication engine, data from the memory; encrypting, by a cybersecurity module, the data accessed by the bus communication engine; and sending, by the bus communication engine, the encrypted data from the communication control to the engine control over a bus.

A system, comprising: a supervisory control connected to a plurality of communication controls via a bus; a sensor defining a control parameter; a distributed control module configured to be associated with the sensor; a digital link; and a first communications control of the plurality of communications controls, the distributed control module connected to the first communication control of the plurality of communications controls via the digital link, the first communication control of the plurality of communications controls comprising: a bus communication engine configured to communicate with the supervisory control via the bus; and a memory, comprising: a first buffer that is configured to send data to and receive data from the distributed control module over the digital link; and a second buffer that is configured to send data to and receive data from the supervisory control via the bus.

We claim:

1. A control system for an engine, the engine comprising an engine control and a sensor defining a control parameter, the sensor configured to measure the control parameter of the engine, the control system comprising:
a distributed control module configured to be associated with the sensor;
a digital link; and
a communications control, the distributed control module connected to the communication control via the digital link, the communication control comprising:
a bus communication engine configured to communicate with the engine control via a bus; and
a memory, comprising:
a first buffer that is configured to send data to and receive data from the distributed control module over the digital link; and
a second buffer that is configured to send data to and receive data from the engine control via the bus.

2. The control system of claim 1, wherein the distributed control module is associated with an actuator of the engine.

3. The control system of claim 1, wherein the sensor and the distributed control module are configured to operate in a high temperature environment.

4. The control system of claim 1, wherein data is at least one of sent and received one bit at a time, sequentially, over the digital link.

5. The control system of claim 1, wherein the distributed control module is configured to send a measurement of the control parameter over the digital link.

6. The control system of claim 5, wherein the control parameter is one of a plurality of control parameters, wherein the sensor is one of a plurality of sensors, wherein the first buffer includes a first record including a first plurality of measurements of control parameters from the plurality of sensors, wherein each of the first plurality of measurements of control parameters in the first record has a first time stamp.

7. The control system of claim 6, wherein the first buffer is configured to send the first record to the second buffer.

8. The control system of claim 7, wherein, after sending the first record to the second buffer, the first buffer includes a second record including a second plurality of measurements of control parameters from the plurality of sensors, wherein each of the second plurality of measurements of control parameters in the second record has a second time stamp, wherein the second time stamp is different from the first time stamp.

9. The control system of claim 5, wherein the measurement of the control parameter from the sensor is mapped to at least one of an address and a location of the first buffer.

10. The control system of claim 1, wherein the bus communication engine is configured to perform at least one of data preprocessing, encryption, bus protocol management, and transmission.

11. The control system of claim 1, wherein the engine control includes at least one of a full authority digital engine control and an engine control unit.

12. The control system of claim 1, wherein the communication control is an intermediate interface between the distributed control module and the engine control.

13. A method of controlling an engine, comprising:
measuring a first measurement of a control parameter of the engine with a sensor;
sending, over a digital link, from a distributed control module associated with the sensor, the first measurement of the control parameter to a first buffer of a memory; and
wherein a communication control includes the memory and the memory further includes a second buffer that is associated with a bus communication engine of the communication control, wherein the communication control is an intermediate interface between the distributed control module and an engine control.

14. The method of claim 13, wherein sending over the digital link includes sending data one bit at a time, sequentially.

15. The method of claim 13, wherein sending over the digital link includes sending data asynchronously with respect to data sent or received at the second buffer.

16. The method of claim 13, wherein sending to the first buffer includes sending the first measurement of the control parameter to at least one of an address and a location of the first buffer that is mapped to the control parameter.

17. The method of claim 13, wherein the first buffer includes a first record including a first plurality of measurements of control parameters from a plurality of sensors, wherein sending over the digital link includes writing the first measurement of the control parameter to the first record.

18. The method of claim 17, comprising sending the first record from the first buffer to the memory for access by the bus communication engine, wherein each of the first plurality of measurements of control parameters in the first record has a first time stamp; and
sending, over the digital link, from the distributed control module associated with the sensor, a second measurement of the control parameter to the first buffer of the memory;
wherein the first buffer includes a second record including a second plurality of measurements of control parameters from the plurality of sensors, wherein sending over the digital link includes writing the second measurement of the control parameter to the second record; and
wherein each of the second plurality of measurements of control parameters in the second record have a second time stamp, wherein the second time stamp is different from the first time stamp.

19. The method of claim 13, comprising:
accessing, by the bus communication engine, data from the memory;
encrypting, by a cybersecurity module, the data accessed by the bus communication engine; and
sending, by the bus communication engine, the encrypted data from the communication control to the engine control over a bus.

20. A system, comprising:
a supervisory control connected to a plurality of communication controls via a bus;
a sensor defining a control parameter;
a distributed control module configured to be associated with the sensor;
a digital link; and
a first communications control of the plurality of communications controls, the distributed control module connected to the first communication control of the plurality of communications controls via the digital link, the first communication control of the plurality of communications controls comprising:
a bus communication engine configured to communicate with the supervisory control via the bus; and
a memory, comprising:
a first buffer that is configured to send data to and receive data from the distributed control module over the digital link; and
a second buffer that is configured to send data to and receive data from the supervisory control via the bus.
